(19) United States
(12) Patent Application Publication
(10) Pub. No.: US 2023/0345303 A1
(43) Pub. Date: Oct. 26, 2023

(54) COMMUNICATIONS DEVICE AND METHOD FOR RECEIVING AGGREGATE PACKET

(71) Applicant: Realtek Semiconductor Corp., HsinChu (TW)

(72) Inventors: Lun-Wu Yeh, HsinChu (TW); Chin-Lung Hsieh, HsinChu (TW)

(73) Assignee: Realtek Semiconductor Corp., HsinChu (TW)

(21) Appl. No.: 18/095,506

(22) Filed: Jan. 10, 2023

(30) Foreign Application Priority Data
Apr. 20, 2022 (TW) 111114991

(51) Int. Cl. H04W 28/06; H04L 1/00

(52) U.S. Cl. CPC H04W 28/065; H04L 1/0008; H04L 1/0083

(57) ABSTRACT

A communications device and a method for receiving an aggregate packet are provided. The communications device includes an aggregate packet de-aggregation device and a transmission interface. The aggregate packet de-aggregation device is configured to generate multiple subframe packets according to the aggregate packet, wherein a length of each of the multiple subframe packets is less than a length of the aggregate packet. The transmission interface is configured to couple the communications device to a host device, and transmits the multiple subframe packets to the host device, to allow the host device to pre-allocate multiple buffering spaces for receiving the multiple subframe packets according to a maximum allowable length of any of the multiple subframe packets.

### BACKGROUND OF THE INVENTION

### 1. Field of the Invention

The present invention is related to packet transmission, and more particularly, to a communications device and a method for receiving an aggregate packet.

### 2. Description of the Prior Art

Wi-Fi performs transmission based on contention windows. Rather than completing transmission of multiple packets over multiple operations, it is preferable to combine the multiple packets into one aggregate packet, which allows the multiple packets to be transmitted in a single operation. When an electronic device receives the aggregate packet, it is typical to de-aggregate the aggregate packet by a software driver program to obtain the multiple packets. The driver program is unable to predict a size of the received packet every time, however. It therefore allocates the required register spaces for processing the packets based on a length limit specified in a communications standard. The disadvantage is that memory resources are easily occupied which introduces waste of the memory resources.

Thus, there is a need for a novel architecture and method that can improve usage efficiency of the memory resources without introducing any side effect or in a way that is less likely to introduce side effects.

### SUMMARY OF THE INVENTION

An objective of the present invention is to provide a communications device and a method for receiving an aggregate packet, to make a driver program of a host device be able to pre-allocate the required buffering spaces based on a shorter packet length.

At least one embodiment of the present invention provides a communications device. The communications device may comprise an aggregate packet de-aggregation device and a transmission interface. The aggregate packet de-aggregation device may be configured to generate multiple subframe packets according to an aggregate packet, wherein a length of each of the multiple subframe packets is less than a length of the aggregate packet. The transmission interface may be configured to couple the communications device to a host device. More particularly, the transmission interface may transmit the multiple subframe packets to the host device, to allow the host device to pre-allocate multiple buffering spaces for receiving the multiple subframe packets according to a maximum allowable length of any of the multiple subframe packets.

At least one embodiment of the present invention provides a method for receiving an aggregate packet. The method may comprise: utilizing an aggregate packet de-aggregation device of a communications device to generate multiple subframe packets according to the aggregate packet, wherein a length of each of the multiple subframe packets is less than a length of the aggregate packet; and utilizing a transmission interface of the communications device to transmit the multiple subframe packets from the communications device to the host device, to allow the host device to pre-allocate multiple buffering spaces for receiving the multiple subframe packets according to a maximum allowable length of any of the multiple subframe packets.

The communications device and the method provided by the embodiments of the present invention can perform de-aggregation on the received aggregate packet in a hardware manner, so that the host device merely needs to satisfy a length requirement of the subframe packets when performing pre-allocation of the buffering spaces. Thus, no matter whether a unit packet having a shorter length such as a medium access control (MAC) service data unit (MSDU) or an aggregate packet having a longer length such as an aggregate MSDU (AMSDU) is received, the present invention can ensure that pre-allocating the buffering spaces based on the length of the unit packet is able to meet the length requirement. It is not necessary to pre-allocate the buffering spaces based on the length of the aggregate packet. Thus, the usage efficiency of the memory resources can be properly improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communications device coupled to a host device according to an embodiment of the present invention.

FIG. 2 is a diagram illustrating an aggregate packet de-aggregation device according to an embodiment of the present invention.

FIG. 3 is a diagram illustrating a working flow of the aggregate packet de-aggregation device shown in FIG. 2 processing a received packet according to an embodiment of the present invention.

FIG. 4 is a diagram illustrating an aggregate packet according to an embodiment of the present invention.

FIG. 5 is a diagram illustrating performing payload alignment on multiple subframe packets according to an embodiment of the present invention.

FIG. 6 is a diagram illustrating a host device pre-allocating buffering spaces under a condition where a de-aggregation function of an aggregate packet de-aggregation device is disabled according to an embodiment of the present invention.

FIG. 7 is a diagram illustrating a host device pre-allocating buffering spaces under a condition where a de-aggregation function of an aggregate packet de-aggregation device is enabled according to an embodiment of the present invention.

FIG. 8 is a diagram illustrating a working flow of a method for receiving an aggregate packet according to an embodiment of the present invention.

### DETAILED DESCRIPTION

Wi-Fi packets can be transmitted in medium access control (MAC) service data units (MSDUs) specified by IEEE 802.11 standard. When a transmitter attempts to transmit multiple MSDU packets, the transmitter may aggregate the multiple MSDU packets into one aggregate MSDU (AMSDU) packet, to make the multiple MSDU packets be sent more efficiently under a protocol based on contention windows.

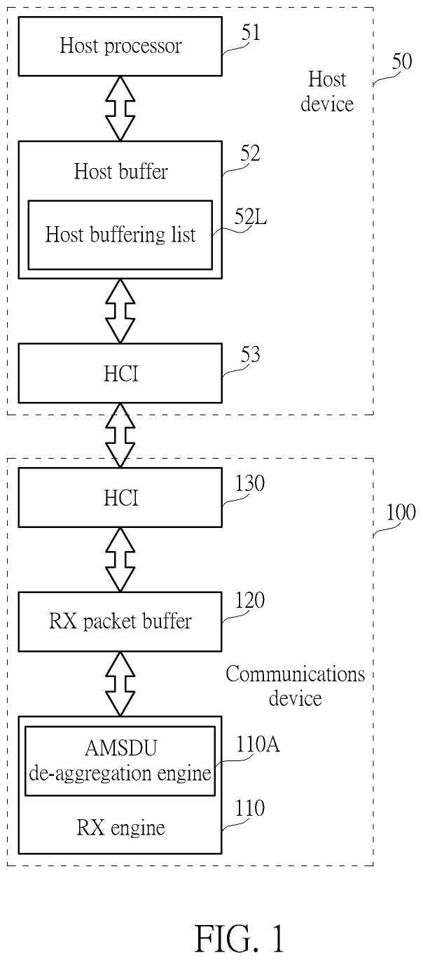

FIG. 1 is a diagram illustrating a communications device 100 coupled to a host device 50 according to an embodiment of the present invention, where the communications device may be implemented in a wired/wireless network interface card to provide network communications service for the host device 50. As shown in FIG. 1, the communications device 100 may comprise a receiver (RX) engine 110, an RX packet buffer 120 and a transmission interface such as a Host controller interface (HCI) 130, where the RX engine 110 may comprise an aggregate packet de-aggregation device such as an AMSDU de-aggregation engine 110A. In particular, the RX engine may comprise multiple layers of circuits such as a radio frequency (RF) circuit layer, a baseband circuit layer and a MAC layer, where the AMSDU de-aggregation engine 110A may be implemented on the MAC layer, but the present invention is not limited thereto. In some embodiments, the AMSDU de-aggregation engine 110A may be built outside the RX engine 110. For example, the AMSDU de-aggregation engine 110A may be coupled between the RX engine 110 and the RX packet buffer 120. In addition, the host device may comprise a host processor 51, a host buffer 52 and a transmission interface such as a HCI 53. The HCI 53 of the host device 50 and the HCI 130 of the communications device 100 may be transmission interfaces conforming to a Peripheral Component Interconnect Express (PCIe) standard or a Universal Serial Bus (USB) standard, but the present invention is not limited thereto.

In this embodiment, when the communications device 100 receives an AMSDU packet, the AMSDU de-aggregation engine 110A may generate multiple subframe packets such as multiple MSDU packets according to the AMSDU packet, where a length of each of the multiple MSDU packets is less than a length of the AMSDU packet. The RX packet buffer 120 may register or buffer the multiple MSDU packets output by the AMSDU de-aggregation engine 110A and transmit the multiple MSDU packets to the HCI 130. The HCI 130 may be configured to couple the communications device 100 to the host device 50 (e.g. coupled to the HCI 53 of the host device 50), where the HCI 130 may transmit the multiple MSDU packets to the host device 50, to allow the host device 50 to pre-allocate multiple buffering spaces such as the host buffering list 52L for receiving the multiple MSDU packets according to a maximum allowable length of any of the multiple MSDU packets (e.g. a maximum allowable length specified by the IEEE 802.11 standard). For example, the host device 50 may receive packets (e.g. the multiple MSDU packets) from the communications device 100 based on a condition of pre-allocating the multiple buffering spaces according to the maximum allowable length of the MSDU packet specified by the IEEE 802.11 standard mentioned above, for subsequent processing and usage.

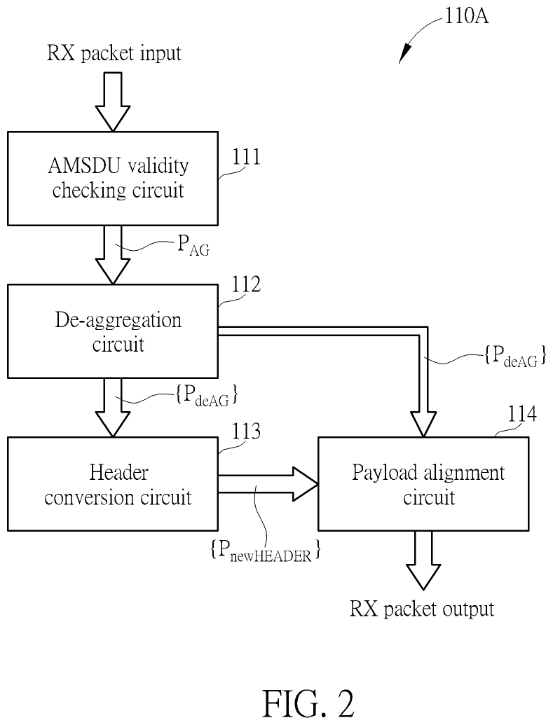

FIG. 2 is a diagram illustrating the AMSDU de-aggregation engine 110A according to an embodiment of the present invention. As shown in FIG. 2, the AMSDU de-aggregation engine 110A may comprise an AMSDU validity checking circuit 111, a de-aggregation circuit 112, a header conversion circuit 113 and a payload alignment circuit 114. For better illustration, assume that three MSDU packets are aggregated into an AMSDU packet P_{AG} at a transmitter. In this embodiment, the AMSDU packet P_{AG} may comprise multiple fields such as {RX_Desc, MAC_header, AMSDU_subframe_1, Padding_1, AMSDU_subframe_2, Padding_2, AMSDU_subframe_3, Padding_3, FCS}, where RX_Desc is a descriptor of the AMSDU packet P_{AG}, MAC_header is a header corresponding to a protocol utilized for transmitting the AMSDU packet P_{AG} (more particularly, a field which indicates, but no limited to, a source address and a destination address of the AMSDU packet P_{AG}), AMSDU_subframe_1, AMSDU_subframe_2 and AMSDU_subframe_3 are subframes respectively corresponding to the three MSDU packets, Padding_1, Padding_2 and Padding_3 are padding bytes, and FCS is a check code. When the AMSDU de-aggregation engine 110A receives a packet (e.g. the AMSDU packet P_{AG}), the AMSDU validity checking circuit 111 may check whether a sum of at least one length (e.g. one or more lengths) indicated by packet length information carried by length fields of the AMSDU packet P_{AG} (e.g., packet length information carried by length fields of the descriptor RX_Desc and/or the subframes AMSDU_subframe_1, AMSDU_subframe_2 and AMSDU_subframe_3) is equal to a total length of the AMSDU packet P_{AG}, where if the sum of the at least one length indicated by the packet length information carried by the length fields of the AMSDU packet P_{AG} is not equal to the total length of the AMSDU packet P_{AG}, the AMSDU validity checking circuit 111 will determine that the AMSDU packet P_{AG} is an invalid AMSDU packet. In addition, the AMSDU validity checking circuit 111 may check whether the total length of the AMSDU packet P_{AG} is less than the maximum allowable length of one AMSDU packet specified in the IEEE 802.11 standard, where if the total length of the AMSDU packet P_{AG} is greater than the maximum allowable length of one AMSDU packet specified in the IEEE 802.11 standard, the AMSDU validity checking circuit 111 will determine that the AMSDU packet P_{AG} is an invalid AMSDU packet. If the AMSDU validity checking circuit 111 determines that the AMSDU packet P_{AG} is a valid AMSDU packet, the AMSDU validity checking circuit 111 may transmit the AMSDU packet P_{AG} to the de-aggregation circuit 112.

The de-aggregation circuit 112 may perform de-aggregation on the AMSDU packet P_{AG} to generate multiple de-aggregation packets {P_{deAG}} (e.g. generating a first de-aggregation packet, a second de-aggregation packet and a third de-aggregation packet), where the multiple MSDU packets output from the communications device 100 to the host device 50 (e.g. the MSDU packets generated by the AMSDU de-aggregation engine 110A mentioned above) are generated according to the multiple de-aggregation packets {P_{deAG}} (e.g. the first de-aggregation packet, the second de-aggregation packet and the third de-aggregation packet), respectively. In addition, each de-aggregation packet of the multiple de-aggregation packets {P_{deAG}} may have a descriptor configured to carry information of said each de-aggregation packet (e.g. a packet index value, a packet length, a packet type of said each de-aggregation packet and/or information indicating whether this de-aggregation packet has been de-aggregated). Thus, the information of said each de-aggregation packet (e.g. the packet index value and the packet length mentioned above) may indicate whether said each de-aggregation packet is a last de-aggregation packet of the multiple de-aggregation packets {P_{deAG}} and also indicate the length of said each de-aggregation packet. In some embodiments, the header MAC_header of AMSDU packet P_{AG} may be kept or discarded in one or more of the multiple de-aggregation packets {P_{deAG}}. In some embodiments, one or more of the padding bytes Padding_1, Padding _2 and Padding _3 of the AMSDU packet P_{AG} of the AMSDU packet P_{AG} may be kept or discarded in one or more of the multiple de-aggregation packets {P_{deAG}}. In some embodiments, the check code FCS of the AMSDU packet P_{AG} of the AMSDU packet P_{AG} may be kept or discarded in any of the multiple de-aggregation packets {P_{deAG}}.

For example, the de-aggregation circuit 112 may keep the header MAC_header and the padding byte Padding _1 in the first de-aggregation packet, keep the padding byte Padding_2 in the second de-aggregation packet, and keep the check code FCS in the third de-aggregation packet. Thus, the first de-aggregation packet may be expressed by {RX_Desc_1, MAC_header, AMSDU_subframe_1, Padding_1}, the second de-aggregation packet may be expressed by {RX_Desc_2, AMSDU_subframe_2, Padding_2}, and the third de-aggregation packet may be expressed by {RX_Desc_3, AMSDU_subframe_3, FCS}, where the descriptor RX_Desc_1 may carry information (e.g. a packet index and/or a packet length) of the first de-aggregation packet, the descriptor RX_Desc_2 may carry information (e.g. a packet index and/or a packet length) of the second de-aggregation packet, and the descriptor RX_Desc_3 may carry information (e.g. a packet index and/or a packet length) of the third de-aggregation packet. In another example, for all of the first de-aggregation packet, the second de-aggregation packet and the third de-aggregation packet, the de-aggregation circuit 112 may keep the header MAC_header, and discard the padding bytes Padding_1, Padding_2 and Padding_3 and the check code FCS. Thus, the first de-aggregation packet may be expressed by {RX_Desc_1, MAC_header, Payload_1}, the second de-aggregation packet may be expressed by {RX_Desc_2, MAC_header, Payload_2}, and the third de-aggregation packet may be expressed by {RX_Desc_3, MAC_header, Payload_3}, where Payload_1 is a data payload within the subframe AMSDU_subframe_1, Payload_2 is a data payload within the subframe AMSDU_subframe_2, and Payload_3 is a data payload within the subframe AMSDU_subframe_3. In another example, the de-aggregation circuit 112 may discard the header MAC_header, the padding bytes Padding_1, Padding_2 and Padding_3 and the check code FCS. Thus, the first de-aggregation packet may be expressed by {RX_Desc_1, Payload_1}, the second de-aggregation packet may be expressed by {RX_Desc_2, Payload_2}, and the third de-aggregation packet may be expressed by {RX_Desc_3, Payload_3}.

The header conversion circuit 113 may perform header conversion on the multiple de-aggregation packets {P_{deAG}} to generate multiple converted packets {P_{newHEADER}}, respectively (e.g. a first converted packet, a second converted packet and a third converted packet), where each converted packet of the multiple converted packets {P_{newHEADER}} may have a specific header, to allow the host device 50 to perform subsequent transmission according to a communications standard corresponding to the specific header. For example, an access point (AP) device may comprise the host device 50, and the AP device may further transmit multiple MSDU packets (which are output from the communications device 100 to the host device 50) to other electronic devices according to the communications standard corresponding to the specific header, where the multiple MSDU packets are generated according to the multiple converted packets {P_{newHEADER}} (e.g. the first converted packet, the second converted packet and the third converted packet).

For example, the header conversion circuit 113 may convert or translate the header MAC_header into a header 802.3_eth_II conforming to IEEE 802.3 Ethernet-II standard. Thus, the first de-aggregation packet may be expressed as {RX_Desc_1, 802.3_eth_II, Payload_1}, the second de-aggregation packet may be expressed as {RX_Desc_2, 802.3_eth_II, Payload_2}, and the third de-aggregation packet may be expressed as {RX_Desc 3, 802.3_eth_II, Payload_3}. In another example, the header conversion circuit 113 may convert or translate the header MAC_header into a header 802.3_SNAP conforming to IEEE 802.3 Sub-network Access Protocol (SNAP) standard. Thus, the first de-aggregation packet may be expressed as {RX_Desc_1, 802.3_SNAP, Payload_1}, the second de-aggregation packet may be expressed as {RX_Desc_2, 802.3_SNAP, Payload_2}, and the third de-aggregation packet may be expressed as {RX_Desc_3, 802.3_SNAP, Payload_3}. In another example, the header conversion circuit 113 may convert or translate the header MAC_header into a header Self_defined conforming to a self-defined standard. Thus, the first de-aggregation packet may be expressed as {RX_Desc_1, Self_defined, Payload_1}, the second de-aggregation packet may be expressed as {RX_Desc_2, Self_defined, Payload_2}, and the third de-aggregation packet may be expressed as {RX_Desc_3, Self_defined, Payload_3}.

If the header conversion circuit 113 is disabled, the payload alignment circuit 114 may obtain the multiple de-aggregation packet {P_{deAG}} from the de-aggregation circuit 112, and add padding bytes to the multiple de-aggregation packet {P_{deAG}} to generate multiple aligned packets, respectively, where respective payloads (e.g. the data payloads Payload_1, Payload_2 and Payload_3 mentioned above) of the multiple aligned packets align with one another based on a specific number of bytes: for example, aligning with one another based on 4 byes, aligning with one another based on 8 byes, aligning with one another based on 4 byes, or aligning with one another based on cache line sizes such as 32 bytes, 64 bytes or 128 bytes, in order to improve the efficiency of the host device 50 processing multiple MSDU packets output to the host device 50 from the communications device 100, where the multiple MSDU packets are generated according to the multiple aligned packets. If the header conversion circuit 113 is enabled, the payload alignment circuit 113 may obtain the multiple converted packets {P_{newHEADER}} from the header conversion circuit 113, and add padding bytes to the multiple converted packets {P_{newHEADER}} to generate the multiple aligned packets, respectively. It should be noted that FIG. 2 shows the signal path of the condition of disabling the header conversion circuit 113 and the signal path of the condition of enabling the header conversion circuit 113 at the same time, but this is for illustrative purposes only. In practice, these are selective operations. When the header conversion circuit 113 is disabled, the payload alignment circuit 114 may stop obtaining the converted packets {P_{newHEADER}} from the header conversion circuit 113; and when the header conversion circuit 113 is enabled, the payload alignment circuit 114 may stop obtaining the multiple de-aggregation packets {P_{deAG}} from the de-aggregation circuit 112, but the present invention is not limited thereto.

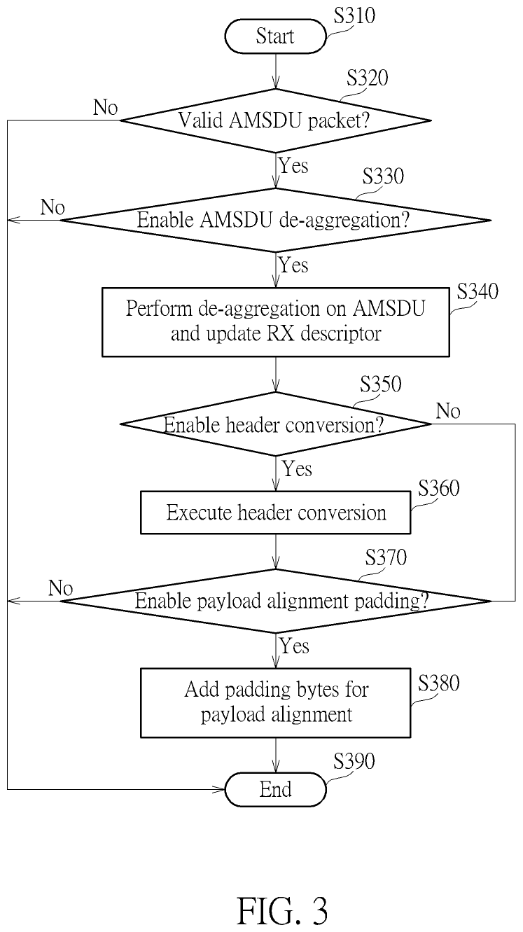

FIG. 3 is a diagram illustrating a working flow of the AMSDU de-aggregation engine 110A shown in FIG. 2 processing a received packet according to an embodiment of the present invention. It should be noted that the working flow shown in FIG. 3 is for illustrative purposes only, and is not meant to be a limitation of the present invention. More particularly, one or more steps may be added, deleted or modified in the working flow shown in FIG. 3. In addition, as long as an overall result is not hindered, these steps do not have to be executed in the exact order shown in FIG. 3.

In Step S310, when the AMSDU de-aggregation engine 110A receives a received packet, the flow starts.

In Step S320, the AMSDU de-aggregation packet 110A may determine whether the received packet is a valid AMSDU packet (labeled “Valid AMSDU packet?” in FIG. 3 for brevity). If the determination shows “Yes”, the flow proceeds with Step S330; if the determination shows “No”, the flow proceeds with Step S390.

In Step S330, the AMSDU de-aggregation engine 110A may determine whether a function of performing de-aggregation on the AMSDU packet is enabled (labeled “Enable AMSDU de-aggregation?” in FIG. 3 for brevity). If the determination shows “Yes”, the flow proceeds with Step S340; if the determination shows “No”, the flow proceeds with Step S390.

In Step S340, the AMSDU de-aggregation engine 110A may utilize the de-aggregation circuit 112 to perform de-aggregation on the AMSDU packet to generate multiple de-aggregation packets, and update a receiving descriptor to the multiple de-aggregation packets (labeled “Perform de-aggregation on AMSDU and update RX descriptor” in FIG. 3 for brevity).

In Step S350, the AMSDU de-aggregation engine 110A may determine whether a function of performing header conversion on the multiple de-aggregation packets is enabled (labeled “Enable header conversion?” in FIG. 3 for brevity). If the determination shows “Yes”, the flow proceeds with Step S360; if the determination shows “No”, the flow proceeds with Step S370.

In Step S360, the AMSDU de-aggregation engine 110A may utilize the header conversion circuit 113 to execute header conversion on the multiple de-aggregation packets to generate multiple converted packets (labeled “Execute header conversion” in FIG. 3 for brevity).

In Step S370, the AMSDU de-aggregation engine 110A may determine whether a function of performing payload alignment padding on the multiple de-aggregation packets or the multiple converted packets is enabled (labeled “Enable payload alignment padding?” in FIG. 3 for brevity). If the determination shows “Yes”, the flow proceeds with Step S380; if the determination shows “No”, the flow proceeds with Step S390.

In Step S380, the AMSDU de-aggregation engine 110A may add padding bytes to the multiple de-aggregation packets or the multiple converted packets for data payload alignment (labeled “Add padding bytes for payload alignment” in FIG. 3 for brevity).

In Step S390, the working flow of the AMSDU de-aggregation engine 110A ends, and multiple final MSDU packets may be output to the RX packet buffer 120.

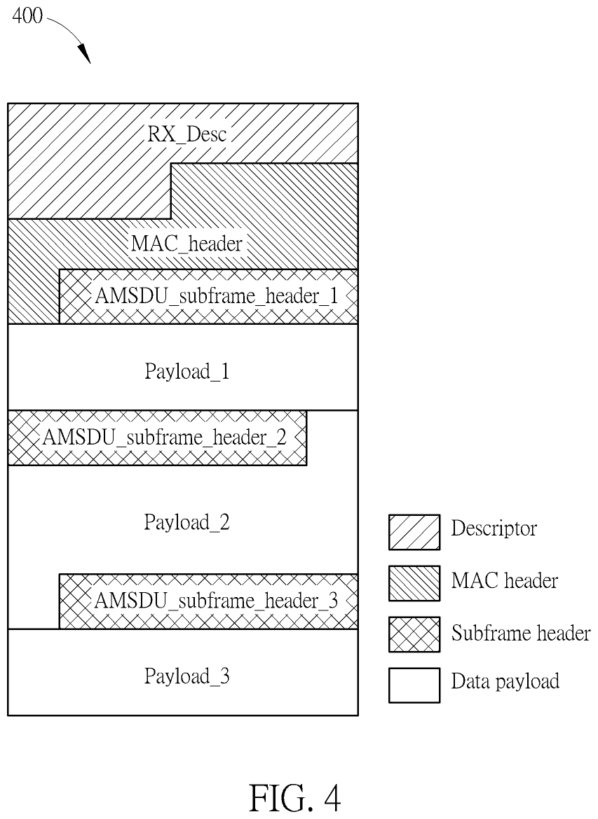

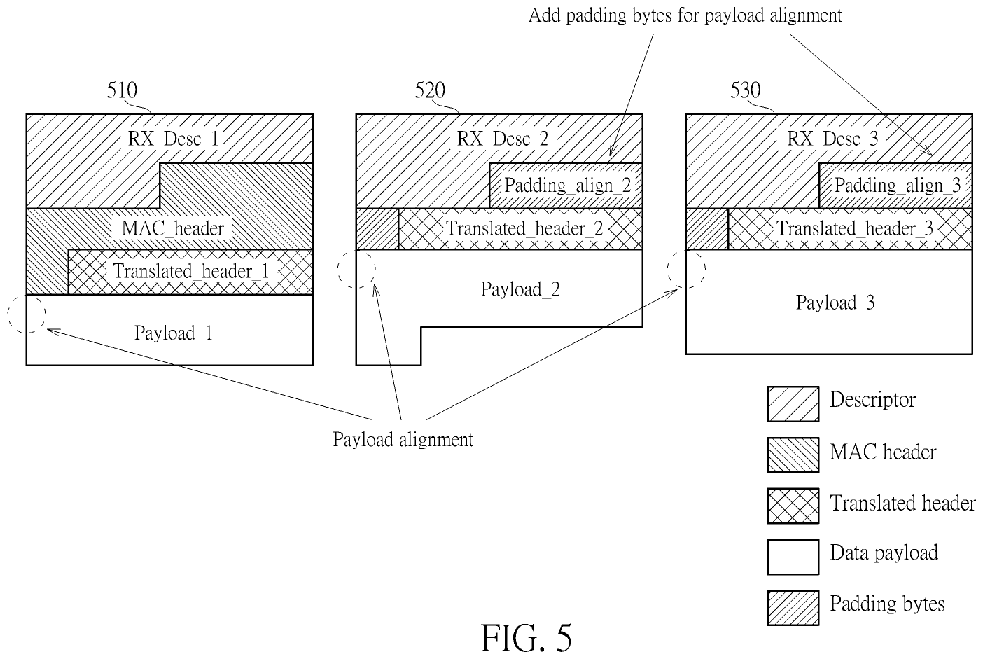

FIG. 4 is a diagram illustrating an AMSDU packet 400 according to an embodiment of the present invention. As shown in FIG. 4, the AMSDU packet 400 may comprise multiple fields such as a descriptor RX_Desc, a MAC header MAC_header, a subframe header AMSDU_subframe_header_1, a data payload Payload_1, a subframe header AMSDU_subframe_header_2, a data payload Payload_2, a subframe header AMSDU_subframe_header_3 and a data payload Payload_3. After the AMSDU de-aggregation engine 110A (e.g. the de-aggregation circuit 112, the header conversion circuit 113 and the payload alignment 114 therein) execute the above processing on the AMSDU packet 400, the AMSDU de-aggregation engine 110A may generate multiple subframe packets such as MSDU packets 510, 520 and 530 shown in FIG. 5.

In the embodiment of FIG. 5, the MSDU packet 510 may comprise multiple fields such as a descriptor RX_Desc_1, MAC_header MAC_header, a translated header Translated_header_1 and a data payload Payload_1. The MSDU packet 520 may comprise multiple fields such as a descriptor RX_Desc_2, padding bytes Padding_align_2, a translated header Translated_header_2 and a data payload Payload_2. The MSDU packet 530 may comprise multiple fields such as a descriptor RX_Desc_3, padding bytes Padding_align_3, a translated header Translated_header_3 and a data payload Payload_3. As shown in FIG. 5, by adding the padding bytes Padding_align_2 and Padding_align_3 to the MSDU packets 520 and 530, respectively, starting bytes of the data payloads Payload_1, Payload_2 and Payload_3 can be aligned with one another based on an integer multiple of a specific number of bytes, for example, be aligned based on 4 bytes, 8 bytes, . . . , or cache line sizes (e.g. 32 bytes, 64 bytes, 128 bytes), to enable the host device 50 to perform subsequent processing with a better efficiency when the MSDU packets 510, 520 and 530 are received.

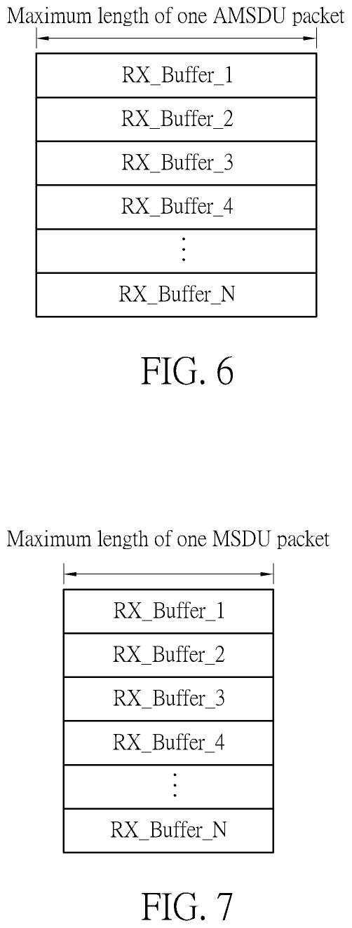

FIG. 6 is a diagram illustrating the host device 50 pre-allocating buffering spaces such as the host buffering list 52L shown in FIG. 1 under a condition of the AMSDU de-aggregation engine 110A being disabled according to an embodiment of the present invention. When the AMSDU de-aggregation engine 110A is disabled, the RX engine 110 may bypass the AMSDU de-aggregation engine 110A when any packet is received, making the host device obtain a packet without any pre-processing. Under this condition, as the host device 50 is unable to expect whether this packet is an MSDU packet or an AMSDU packet, the host device may determine a size of each buffering entry of buffering entries RX_Buffer_1, RX_Buffer_2, RX_Buffer_3, RX_Buffer_4, . . . and RX_Buffer_N of the host buffering list 52L according to the maximum allowable length of one AMSDU packet specified in the IEEE 802.11 standard, in order to ensure that the pre-allocated buffering spaces satisfy the requirement of this packet, where N is a positive integer.

FIG. 7 is a diagram illustrating the host device 50 pre-allocating buffering spaces such as the host buffering list 52L shown in FIG. 1 under a condition of the AMSDU de-aggregation engine 110A being enabled according to an embodiment of the present invention. If the RX engine 110 receives an MSDU packet, the RX engine 110 may bypass the AMSDU de-aggregation engine 110A to send the MSDU packet backwards; and if the RX engine 110 receives an AMSDU packet, the AMSDU de-aggregation engine 110A may perform de-aggregation on this AMSDU packet to generate multiple MSDU packets. Thus, no matter which type of packet is received by the RX engine 110, it can be ensured that taking the maximum allowable length of one MSDU packet specified in the IEEE 802.11 standard to be the size of each buffering entry of the buffering entries RX_Buffer_1, RX_Buffer_2, RX_Buffer_3, RX_Buffer 4, . . . and RX_Buffer_N of the host buffering list 52L satisfies the requirement.

For example, the maximum allowable length of one MSDU packet specified in the IEEE 802.11 standard is 2304 bytes, and the maximum allowable length of one AMSDU packet specified in the IEEE 802.11 standard is 7935 bytes. When the host device queues 256 packets in the host buffer 52, 2,031,360 bytes (i.e. 256×7935) of a memory space are required, under a condition where the AMSDU de-aggregation engine 110A is disabled. By comparison, under a condition where the AMSDU de-aggregation engine 110A is enabled, only 589,824 bytes (i.e. 256×2304) of a memory space are required, and the required memory resource can be greatly reduced.

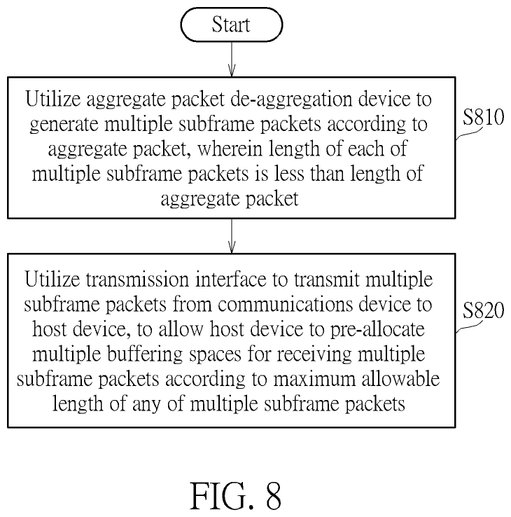

FIG. 8 is a diagram illustrating a working flow of a method for receiving an aggregate packet according to an embodiment of the present invention, where the method is applicable to the communications device 100 shown in FIG. 1. It should be noted that the working flow shown in FIG. 8 is for illustrative purposes only, and is not meant to be a limitation of the present invention. More particularly, one or more steps may be added, deleted for modified in the working flow shown in FIG. 8. In addition, as long as an overall result is not hindered, these steps do not have to be executed in the exact order shown in FIG. 8.

In Step S810, the communications device 100 may utilize an aggregate packet de-aggregation device therein, such as the AMSDU de-aggregation engine 110A shown in FIG. 1, to generate multiple subframe packets such as MSDU packets according to the aggregate packet, wherein a length of each of the multiple subframe packets is less than a length of the aggregate packet.

In Step S820, the communications device 100 may utilize a transmission interface therein, such as the HCI 130 shown in FIG. 1, to transmit the multiple subframe packets from the communications device 100 to the host device 50, to allow the host device 50 to pre-allocate multiple buffering spaces for receiving the multiple subframe packets according to a maximum allowable length of any of the multiple subframe packets.

To summarize, the communications device and the method of the present invention can perform de-aggregation on the AMSDU packet by a hardware manner, to ensure that sizes of packets received by the host device are less than or equal to the maximum allowable length of one MSDU packet specified in the IEEE 802.11 standard. Thus, the memory resource can be utilized in a more efficient way.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications device, comprising:
an aggregate packet de-aggregation device, configured to generate multiple subframe packets according to an aggregate packet, wherein a length of each of the multiple subframe packets is less than a length of the aggregate packet; and
a transmission interface, configured to couple the communications device to a host device;
wherein the transmission interface transmits the multiple subframe packets to the host device, to allow the host device to pre-allocate multiple buffering spaces for receiving the multiple subframe packets according to a maximum allowable length of any of the multiple subframe packets.

2. The communications device of claim 1, wherein the aggregate packet de-aggregation device comprises:
a de-aggregation circuit, configured to perform de-aggregation on the aggregate packet to generate multiple de-aggregation packets, wherein each de-aggregation packet of the multiple de-aggregation packets has a descriptor configured to carry information of said each de-aggregation packet;
wherein the multiple subframe packets are generated according to the multiple de-aggregation packets, respectively.

3. The communications device of claim 2, wherein the information of said each de-aggregation packet indicates whether said each de-aggregation packet is a last de-aggregation packet of the multiple de-aggregation packet.

4. The communications device of claim 2, wherein the information of said each de-aggregation packet indicates a length of said each de-aggregation packet.

5. The communications device of claim 2, wherein the aggregate packet de-aggregation device further comprises:
a payload alignment circuit, configured to add padding bytes to the multiple de-aggregation packets to generate multiple aligned packets, respectively, wherein respective data payloads of the multiple aligned packets are aligned with one another based on a specific number of bytes;
wherein the multiple subframe packets are generated according to the multiple aligned packets, respectively.

6. The communications device of claim 2, wherein the aggregate packet de-aggregation device further comprises:
a header conversion circuit, configured to perform header conversion on the multiple de-aggregation packets to generate multiple converted packets, respectively, wherein each converted packet of the multiple converted packets has a specific header, to allow the host device to perform subsequent communications according to a communications standard corresponding to the specific header;
wherein the multiple subframe packets are generated according to the multiple converted packets, respectively.

7. The communications device of claim 6, wherein the aggregate packet de-aggregation device further comprises:
a payload alignment circuit, configured to add padding bytes to the multiple converted packets to generate multiple aligned packets, respectively, wherein respective data payloads of the multiple aligned packets are aligned with one another based on a specific number of bytes;
wherein the multiple subframe packets are generated according to the multiple aligned packets, respectively.

8. The communications device of claim 6, wherein the aggregate packet has a medium access control (MAC) header, and the specific header is different from the MAC_header.

9. The communications device of claim 1, wherein the aggregate packet is an aggregate medium access control (MAC) service data unit (AMSDU) packet.

10. A method for receiving an aggregate packet, comprising:
utilizing an aggregate packet de-aggregation device of a communications device to generate multiple subframe packets according to the aggregate packet, wherein a length of each of the multiple subframe packets is less than a length of the aggregate packet; and
utilizing a transmission interface of the communications device to transmit the multiple subframe packets from the communications device to the host device, to allow the host device to pre-allocate multiple buffering spaces for receiving the multiple subframe packets according to a maximum allowable length of any of the multiple subframe packets.

11. The method of claim 10, wherein utilizing the aggregate packet de-aggregation device to generate the multiple subframe packets according to the aggregate packet comprises:
utilizing a de-aggregation circuit of the aggregate packet de-aggregation device to perform de-aggregation on the aggregate packet to generate multiple de-aggregation packets, wherein each de-aggregation packet of the multiple de-aggregation packets has a descriptor configured to carry information of said each de-aggregation packet;
wherein the multiple subframe packets are generated according to the multiple de-aggregation packets, respectively.

12. The method of claim 11, wherein the information of said each de-aggregation packet indicates whether said each de-aggregation packet is a last de-aggregation packet of the multiple de-aggregation packet.

13. The method of claim 11, wherein the information of said each de-aggregation packet indicates a length of said each de-aggregation packet.

14. The method of claim 11, wherein utilizing the aggregate packet de-aggregation device to generate the multiple subframe packets according to the aggregate packet further comprises:
utilizing a payload alignment circuit of the aggregate packet de-aggregation device to add padding bytes to the multiple de-aggregation packets to generate multiple aligned packets, respectively, wherein respective data payloads of the multiple aligned packets are aligned with one another based on a specific number of bytes;
wherein the multiple subframe packets are generated according to the multiple aligned packets, respectively.

15. The method of claim 11, wherein utilizing the aggregate packet de-aggregation device to generate the multiple subframe packets according to the aggregate packet further comprises:
utilizing a header conversion circuit of the aggregate packet de-aggregation device to perform header conversion on the multiple de-aggregation packets to generate multiple converted packets, respectively, wherein each converted packet of the multiple converted packets has a specific header, to allow the host device to perform subsequent communications according to a communications standard corresponding to the specific header;
wherein the multiple subframe packets are generated according to the multiple converted packets, respectively.

16. The method of claim 15, wherein utilizing the aggregate packet de-aggregation device to generate the multiple subframe packets according to the aggregate packet further comprises:
utilizing a payload alignment circuit of the aggregate packet de-aggregation device to add padding bytes to the multiple converted packets to generate multiple aligned packets, respectively, wherein respective data payloads of the multiple aligned packets are aligned with one another based on a specific number of bytes;
wherein the multiple subframe packets are generated according to the multiple aligned packets, respectively.

17. The method of claim 15, wherein the aggregate packet has a medium access control (MAC) header, and the specific header is different from the MAC_header.

18. The method of claim 10, wherein the aggregate packet is an aggregate medium access control (MAC) service data unit (AMSDU) packet.
